(19) United States
(12) Patent Application Publication
(10) Pub. No.: US 2002/0017410 A1
(43) Pub. Date: Feb. 14, 2002

(54) Vehicle instrument panel

(76) Inventors: Goran Larsson, Torslanda (SE); Anders Gunnarsson, Goteborg (SE); Simon Lamarre, Vastra Frolunda (SE); Karin Reikeras, Dampierre-en-y (FR); Kjell Reikeras, Hokerum (SE); Einar Lennartsson, Sollebrunn (SE); Birgitta Thorsson, Varberg (SE); Ake Bergqvist, Vastra Frolunda (SE)

Correspondence Address: Tracy W. Druce, Kilpatrick Stockton LLP, Suite 300, 11130 Sunrise Valley Drive, Reston, VA, 20191-4329, US

(21) Appl. No.: 09/882,463

(22) Filed: Jun. 15, 2001

Related U.S. Application Data
(63) Continuation of application No. PCT/SE99/02335, filed on Dec. 14, 1999.

(30) Foreign Application Priority Data
Dec. 12, 1998 (SE) 9804468-8

(51) Int. Cl. B62D 25/14

(52) U.S. Cl. 180/90; 296/70

(57) ABSTRACT

A vehicle instrument panel having along its transverse design length two mounting stations of identical design. Each mounting station is adapted to receive either a module designed for a driver or a module designed for a passenger. Each of the mounting stations includes a recess in the instrument panel adapted for receiving each module. Each mounting station and respective module is designed for docking-like installation and removal of the modules at anytime during the life of the vehicle. Swapping the modules essentially completes the change-over of the driver side and passenger side of the vehicle. Each mounting station includes electrical connection components. The module for the driver includes elements for controlling the vehicle and electronically connect to the electrical connection components in a mounting station.

### CROSS REFERENCE TO RELATED APPLICATIONS

The present invention is a continuation of PCT Application No. PCT/SE99/02335 filed Dec. 14, 1999, which claims priority to Swedish Application No. 9804468-8, filed Dec. 21, 1998.

### BACKGROUND OF THE INVENTION

1. Technical Field

The present invention relates to an instrument panel for a vehicle having two mounting stations along the transverse length of the instrument panel with both mounting stations adapted to receive either a driver module or a passenger module.

2. Background Information

European Patent Application No. 81303083.0 discloses an instrument panel for vehicles. On either side of the center of the instrument panel there is a depression designed to accommodate a connecting part equipped with instruments intended for the instrument panel. In one of the depressions there is a steering wheel mounted on the end of a steering column, which in turn is arranged on a mounting in the vehicle body. The connecting part is located in the depression in which the steering wheel is located and has connection contacts for various instruments. The instrument panel and parts connected thereto, have the same design regardless of whether they are to be installed in a right or left side driven vehicle when assembling the vehicle. However, when manufacturing the vehicle the determination whether the vehicle will be a right side driven vehicle or a left side driven vehicle is made by fitting the steering wheel and associated steering column on the intended driver's side and connections made to the instruments destined for the intended driver's side.

### SUMMARY OF THE INVENTION

An object of the present invention is to provide an instrument panel of modular construction intended for vehicles. Another object of the invention is to provide interchangeable modules in order to allow the vehicle to be changed over from a right side driven vehicle to a left side driven vehicle and vice-versa without the need for a complicated conversion of the vehicle. As a result, the modification can be carried out at any time during the life of the vehicle.

This has been achieved in one embodiment by having two mounting in a vehicle instrument panel with each mounting station receiving either a driver module or a passenger module using docking-like installation and removal of the modules. Thus, the docking-like installation allows for swapping of the modules thereby switching the driver side and passenger side of the vehicle.

The arrangement according to the invention offers a number of advantages. Using an electrical control system for controlling the vehicle, the steering wheel does not need to be mounted in the vehicle body using a conventional steering column. Thus, at the manufacturing stage, provisions are made for conversion of the driver and passenger sides of the vehicle at any time during the life of the vehicle. Hence, this arrangement facilitates the sale of cars between countries that drive on the right side of the road and those which drive on the left side of the road.

### BRIEF DESCRIPTION OF THE DRAWINGS

The present invention will be described below on the basis of an illustrative embodiment and with reference to the attached drawings, in which:

FIG. 1 shows a perspective view of an exemplary instrument panel having a driver side module and a passenger side module in a left side driven vehicle according to an embodiment of the present invention;

FIG. 2 shows the instrument panel of FIG. 1 without the driver side module and passenger side module according to an embodiment of the present invention;

FIG. 3 shows a perspective view of the passenger side module of FIG. 1 viewed obliquely from the rear according to an embodiment of the present invention; and

FIG. 4 shows a perspective view of the driver side module of FIG. 1 viewed obliquely from the rear according to an embodiment of the present invention.

### DETAILED DESCRIPTION OF THE INVENTION

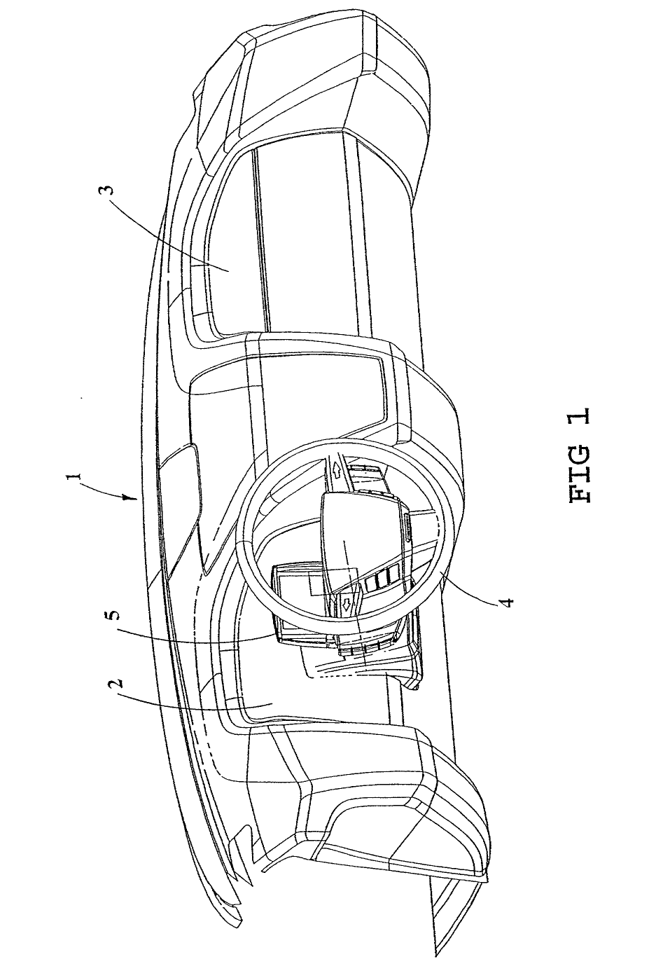

Referring to FIG. 1, an exemplary instrument panel 1 having a driver side module and passenger side module in a left side driven vehicle is illustrated. In the preferred embodiment, the two mounting stations 6, 7 are identical. The mounting stations 6, 7 are located along the transverse length of the instrument panel 1 in a vehicle with each mounting stations 6, 7 being a recess in the instrument panel 1. Each of the mounting stations 6, 7 can receive a module 2 designed for the driver, e.g., driver module 2, and a module 3 designed for the passenger, e.g., passenger module 3. A driver module 2 or passenger module 3 is installed into the instrument panel 1 by inserting the module 2, 3 into one of the mounting stations 6, 7 in a docking-like manner and is removed in a similar manner. After inserting the module 2, 3, the module 2, 3 is locked into the inserted position by means of locking elements (not shown). The module 2, 3 is removed by unlocking the locking elements and removing the module 2, 3 from the respective mounting station 6, 7. Thus, the driver side of the vehicle can be switched to the other side by swapping the driver module 2 with the passenger module 3. As will be appreciated from the description below, only minor installation work, if any, is required in order to complete the change-over of the driver side and the passenger side of the vehicle. The driver module 2 is equipped with a control element comprising a control device 4. Preferably, the control device includes a steering wheel, together with elements (not shown), such as a steering wheel lock and those designed to produce an electrical signal varying as a function of the control movement of the control device. The electrical signal is used by an electrical control system installed in the vehicle for controlling the vehicle. The vehicle can be an electrical or hybrid car, however vehicle propulsion by a conventional internal combustion engine is also conceivable. The only crucial requirement is that the vehicle's control system is designed to eliminate the need for a steering column.

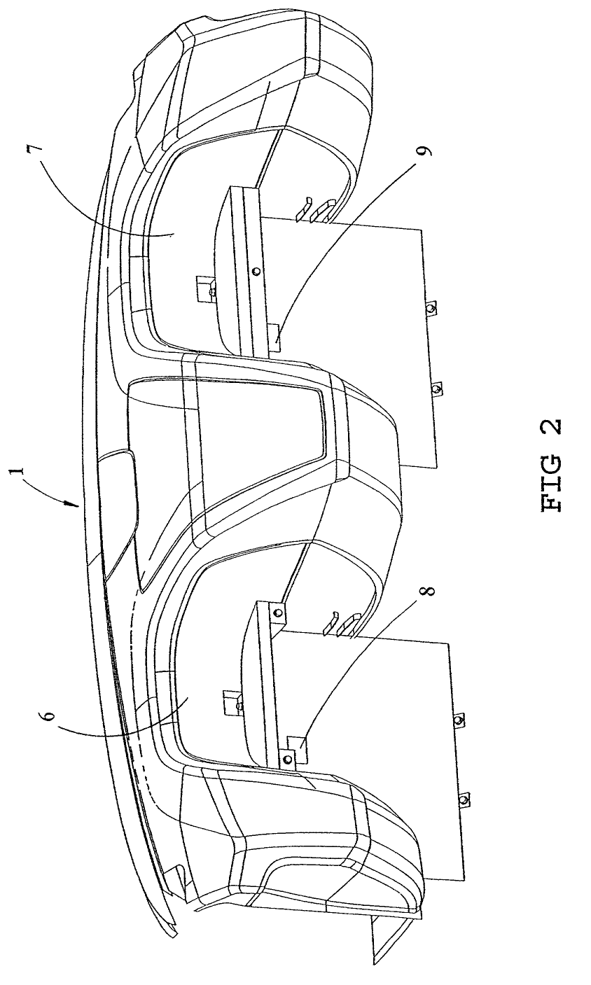

As illustrated in FIG. 2, connection devices 8, 9 are connected to each mounting station 6, 7 respectively and designed to electrically connect the elements to the vehicle control system. The connection devices 8, 9 are also electrically connected to other components in the driver module 2 and are designed to communicate with the vehicle and associated parts of the vehicle. The components can include audio equipment, headlight controls and windscreen wiper controls. In addition, the driver module 2 has a display unit 5 for displaying relevant data for driving the vehicle. The display unit 5 can be powered by current from the vehicle and communicate with a computer either in the driver module 2 or in the vehicle, with the computer supplying the relevant data. Operating control devices can also be fitted to the driver module 2 for accelerating and/or braking of the vehicle together with controls for changing gears and a handbrake. For example, an acceleration module is used for controlling the acceleration of the vehicle and a braking module is used to control the deceleration of the vehicle. In one embodiment, acceleration and/or deceleration can be controlled with either hand. In another embodiment, a separate unit in the driver's module 4 is floor-mounted and provides foot control in the conventional manner. The separate unit can be mounted on or coupled to the driver module 2 so that it follows the movement of the driver module 2. In yet another embodiment, electrical contact devices are mounted in the floor on both the right side of the vehicle and the left side of the vehicle for rapid removal and rapid fitting of accelerator and brake pedals.

The connection devices 8, 9 are electrically connected to at least one component in the passenger module 3 communicating with the vehicle and to associated parts therein. In one embodiment, the passenger module 3 is a storage module, for example a glove compartment, which can be provided with suitable equipment, such as interior lighting for the storage module, reading light and picture monitor/display. Electrical equipment is powered by current from the vehicle, which is supplied by way of the connection devices 8, 9.

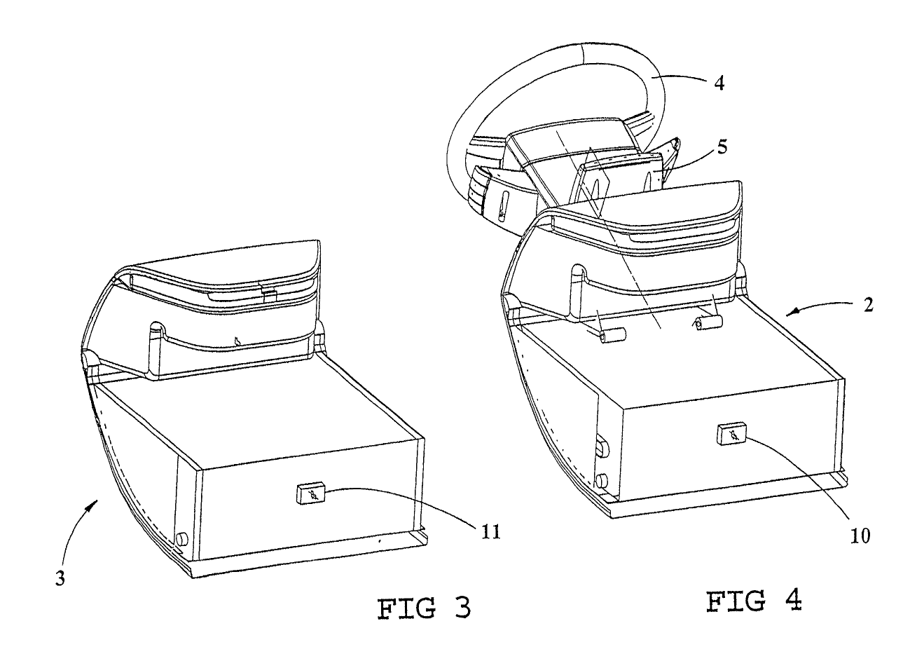

In one embodiment, the connection device 8 or 9 forms part of a multi-pole contact device which connects to a complementary part 10 or 11 on the back of the respective module 2, 3 as shown in FIGS. 3 and 4. In the docking-like installation of the driver module 2 in the associated mounting station 6 or 7, the driver module 2 is electrically connected to the vehicle by way of the contact device for the driver module 2 comprising the connection part 8 and the complementary part 10. In the docking-like installation of the passenger module 3 in the associated mounting station 6 or 7, the passenger module 3 is electrically connected to the vehicle by way of the contact device for the passenger's module 3 comprising the connection part 9 and the complementary part 11. Each contact device part 8, 9, 10, 11 is designed to maintain communications between components of the modules and associated parts in the vehicle, regardless of which of the complementary parts 10, 11 the parts 8, 9 are each connected to, respectively. The contact devices can also comprise poles for connection to a data bus for controlling the vehicle audio system, for example.

Designing the modules in such a way that both the driver module 2 and the passenger module 3 fit both of the mounting stations, together with the fact that the connection devices can be fitted to both of the modules 2, 3 means that the driver side and the passenger side of the vehicle are easily interchangeable. The facility is therefore available for changing the vehicle from left-hand drive to right-hand driver and vice-versa.

Although the present invention has been described and illustrated in detail, it is to be clearly understood that the same is by way of illustration and example only, and is not to be taken as a limitation. The spirit and scope of the present invention are to be limited only by the terms of any claims presented hereafter.

What is claimed is:

1. An instrument panel for a vehicle comprising:
two mounting stations along the transverse length of the instrument panel, both of the mounting stations comprise a recess adapted to receive either a driver module or a passenger module, thereby permitting the swapping of the driver module and passenger module in the recesses; and
an electrical system connected to each mounting station and associated parts of the vehicle for controlling the vehicle by communicating electrical signals from the driver module.

2. The instrument panel according to claim 1 wherein the driver module comprises a control device providing control signals to the electrical system for controlling the vehicle, wherein the control signals are a function of movement of the control device.

3. The instrument panel according to claim 2 wherein the control device is a steering wheel.

4. The instrument panel according to claim 1 wherein each of the mounting stations further comprise a multi-pole contact device for electrically connecting the driver module to the respective mounting station.

5. The instrument panel according to claim 1 wherein the driver module further comprises an accelerator module for causing the vehicle to accelerate when acted upon.

7. The instrument panel according to claim 1 wherein the driver module further comprises a braking module for causing the vehicle to decelerate when acted upon.

8. The instrument panel according to claim 1 wherein the driver module further comprises a display unit for displaying relevant data for driving the vehicle.
